(19) United States
(12) Patent Application Publication
(10) Pub. No.: US 2017/0239992 A1
(43) Pub. Date: Aug. 24, 2017

(54) Pneumatic Tire

(71) Applicant: The Yokohama Rubber Co., LTD., Minato-ku, Tokyo (JP)

(72) Inventor: Masaya Mita, Hiratsuka-shi, Kanagawa (JP)

(21) Appl. No.: 15/519,491

(22) PCT Filed: Oct. 13, 2015
(86) PCT No.: PCT/JP2015/078948

§ 371 Date: Apr. 14, 2017

(30) Foreign Application Priority Data
Oct. 15, 2014 (JP) 2014-210541

(51) Int. Cl. B60C 5/14

(52) U.S. Cl. CPC B60C 5/14; B29D 2030/0066

(57) ABSTRACT

Provided is a pneumatic tire having an innerliner member attached to a tire inner circumferential surface, the innerliner member constituted from at least three layers including a film having, as a main component, a thermoplastic resin or a thermoplastic elastomer composition containing a blend of a thermoplastic resin and an elastomer, and rubber sheets layered on both sides of the film, the tire including a lap splice portion in which tire circumferential direction end portions of the film are overlapped with the rubber sheets interposed therebetween. The rubber sheet on the tire cavity side of the innerliner member disposed on the tire cavity side in the lap splice portion is formed shorter along the tire circumferential length than an adjacent film.

### TECHNICAL FIELD

The present technology relates to a pneumatic tire.

More particularly, the present technology relates to a pneumatic tire having an innerliner member attached to a tire inner circumferential surface, the innerliner member constituted from at least three layers including a film having, as a main component, a thermoplastic resin or a thermoplastic elastomer composition containing a blend of a thermoplastic resin and an elastomer, and rubber sheets layered on both sides of the film, the tire including a lap splice structure in which tire circumferential direction end portions of the film are overlapped with each other with the two rubber sheets interposed therebetween; wherein tire failure does not occur, such as the bonding condition of the lap splice portion loosening due to delamination and the bonded portion opening when the tire is inflated during vulcanization molding, or, as a result thereof, cracking occurring in the vicinity of the lap splice portion after the pneumatic tire starts to travel, and wherein this portion has excellent durability.

### BACKGROUND ART

Various studies have recently been conducted due to the fact that both a reduction in total tire weight and high air permeation preventive properties can be achieved by using a film having, as a main component, a thermoplastic resin or a thermoplastic elastomer composition containing a blend of a thermoplastic resin and an elastomer (see, e.g., Japanese Unexamined Patent Application Publication No. H08-217923A, International Patent Application Publication No. WO 2008/53747, or International Patent Application Publication No. WO 2012/086276).

For example, studies have been conducted on the use of a tire in which an innerliner member constituted from at least three layers including a film having, as a main component, a thermoplastic resin or a thermoplastic elastomer composition containing a blend of a thermoplastic resin and an elastomer, and rubber sheets layered on both sides of the film, is attached to the tire inner circumferential surface. To use an innerliner member of this type as a tire structural member, a production method is employed wherein the innerliner member is wrapped around a tire forming drum, the end portions of the innerliner member are lap spliced, and the tire is subjected to a vulcanization step (see, e.g., Japanese Unexamined Patent Application Publication Nos. 2006-198848A or 2012-6499A).

Specifically, there is a technique of wrapping an innerliner member having such a layered structure around a tire forming drum so as to have a cylindrical shape, and at that time, lap splicing the two circumferential direction end portions to each other and subjecting the tire to a vulcanization molding step to produce a pneumatic tire having a lap spliced innerliner layer.

When such a technique is used, it is preferable to use an innerliner member configured from at least three layers including a film and rubber sheets layered on both sides of the film, because the rubber sheets are overlapped and lap spliced to each other and splicing can be securely performed.

However, during the process from vulcanization molding to immediately after molding, separation occurs at the interfaces of the film and rubber sheets, and further, the joint portion (splice portion) opens, which is thought to be caused by that separation.

To describe this through drawings, as illustrated in FIG. 3A, an innerliner member 1 constituted of at least three layers including a film 2, having, as a main component, a thermoplastic resin or a thermoplastic elastomer composition containing a blend of a thermoplastic resin and an elastomer, and rubber sheets 3A, 3B layered on both sides of the film 2 is formed into a required size determined according to tire size. A lap splice portion 4 is provided on both ends thereof on a tire forming drum 5 illustrated schematically by double-dotted lines. The rubber sheet 3B functions as tie rubber having a function of bonding with other tire components such as a carcass layer.

As illustrated in FIG. 3B, during the process from vulcanization molding to immediately after molding with a bladder, a separation 6 occurs at the interface between the film 2 and the rubber sheet 3A, particularly at the interface in the vicinity of the end portions. Furthermore, opening of the lap splice portion 4 progresses due to that separation. In particular, in the case of the innerliner member 1 having a structure including at least three layers described above, the interface between the film 2 and rubber sheet 3A, particularly the interface in the vicinity of the end portions, tends to become an origin of the separation 6 in the molding process because the adhesion force (tack) between the surface of the forming drum 5 and the rubber sheet 3A is high.

As illustrated in the model diagram of FIG. 3C, after vulcanization molding, the innerliner member itself constitutes an innerliner layer 10, and in the vicinity of the lap splice portion 4, the end portions of the film 2 overlap each other with the rubber sheets 3A, 3B interposed therebetween, forming the lap splice portion 4. In FIG. 3C, the top is the tire outer circumference side, and the bottom is the tire cavity side. Furthermore, the X-X direction is the tire circumferential direction. In the tire as a whole, there is a lap splice portion 4 where the tire circumferential direction ends of the innerliner member 1 overlap across the tire width direction. A pneumatic tire T in which the lap splice portion 4 is present across the tire width direction E-E is formed (FIG. 2).

The problems that separation occurs at the interface between the film 2 and rubber sheet 3A, particularly at the interface in the vicinity of the end portions. Further, that opening of the lap splice portion 4 progresses due to that separation, are problems that occur in the tire vulcanization molding step, and are also thought to be problems that should also be heeded after the pneumatic tire starts to travel. The vicinity of the ends and the like of the film 2 indicated by reference sign 7 in FIG. 3C are the locations where this phenomenon should be heeded.

### SUMMARY

The present technology provides a pneumatic tire having an innerliner member attached to a tire inner circumferential surface, the innerliner member constituted from at least three layers including a film having, as a main component, a thermoplastic resin or a thermoplastic elastomer composition containing a blend of a thermoplastic resin and an elastomer, and rubber sheets layered on both sides of the film, the tire including a lap splice structure in which tire circumferential direction end portions of the film are overlapped with each other with the rubber sheets interposed therebetween; wherein tire failure does not occur, such as the bonding condition of the lap splice portion loosening due to delamination and the bonded portion opening when the tire is inflated during vulcanization molding, or, as a result thereof, cracking occurring in the vicinity of the lap splice portion after the pneumatic tire starts to travel, and wherein this portion has excellent durability.

A pneumatic tire of the present technology has configuration (1) below.

(1) A pneumatic tire having an innerliner member 1 attached to a tire inner circumferential surface, the innerliner member 1 constituted from at least three layers including a film 2 having, as a main component, a thermoplastic resin or a thermoplastic elastomer composition containing a blend of a thermoplastic resin and an elastomer, and rubber sheets 3A, 3B layered on both sides of the film 2, the tire including a lap splice portion 4 in which tire circumferential direction end portions of the film 2 are overlapped with the rubber sheets 3A, 3B interposed therebetween; wherein the rubber sheet 3A on a tire cavity side of the innerliner member 1 disposed on the tire cavity side in the lap splice portion 4 is formed shorter along the tire circumferential length than the adjacent film 2.

The pneumatic tire of the present technology described above preferably has the constitution described in any one of (2) to (4) below.

(2) The pneumatic tire according to the above (1), wherein a relationship between a difference (L) in circumferential length between the rubber sheet 3A on the tire cavity side and the film 2 having a thermoplastic elastomer composition as a main component in the innerliner member 1 disposed on the tire cavity side in the lap splice portion, and a lap splice length (S) of the film 2 having a main component of a thermoplastic elastomer composition, is L≧S.

(3) The pneumatic tire according to the above (1) or (2), wherein a difference (L) in circumferential length between the rubber sheet 3A on the tire cavity side and the film 2 having a thermoplastic elastomer composition as a main component in the innerliner member 1 disposed on the tire cavity side in the lap splice portion is not less than 5 mm and not greater than 50 mm.

(4) The pneumatic tire according to any one of the above (1) to (3), wherein the lap splice length (S) of the film 2 having a thermoplastic elastomer composition as a main component is in a range of 3 to 30 mm.

The present technology according to the above (1) provides a pneumatic tire having an innerliner member attached to a tire inner circumferential surface, the innerliner member constituted from at least three layers including a film having, as a main component, a thermoplastic resin or a thermoplastic elastomer composition containing a blend of a thermoplastic resin and an elastomer, and rubber sheets layered on both sides of the film, the tire including a lap splice structure in which tire circumferential direction end portions of the film are overlapped with each other with the rubber sheets interposed therebetween; wherein tire failure does not occur, such as the bonding condition of the lap splice portion loosening due to delamination and the bonded portion opening when the tire is inflated during vulcanization molding, or, as a result thereof, cracking occurring in the vicinity of the lap splice portion after the pneumatic tire starts to travel, and wherein the splice portion of the innerliner member has excellent durability.

The pneumatic tires of the technologies according to any one of the above (2) to (4) can exhibit more distinctive and greater effects than those obtained by the pneumatic tire of the present technology according to the above (1).

### BRIEF DESCRIPTION OF DRAWINGS

FIGS. 1A and 1B are drawings for illustrating respective example aspects of the pneumatic tire according to the present technology. They are both side views for schematically illustrating examples of a splice portion structure prior to vulcanization molding.

FIG. 2 is a partially fractured perspective view illustrating an example of an aspect of the pneumatic tire according to the present technology. FIG. 2 illustrates the positional relationship of the lap splice portion within the tire when the innerliner member according to the present technology is used.

FIGS. 3A, 3B, and 3C are drawings for illustrating respective problems of conventional art. FIG. 3A schematically illustrates a state in which an innerliner member having a predetermined size (length) is formed into an annular shape on a tire forming drum with a lap splice portion 4 provided on both end portions thereof. FIG. 3B schematically illustrates a state in which separation has occurred between the film and the rubber sheet during vulcanization molding of the tire in the state illustrated in FIG. 3A. FIG. 3C is a side view schematically illustrating an example of a splice portion structure after vulcanization molding.

### DETAILED DESCRIPTION

A more detailed description of the pneumatic tire of the present technology will be given below with reference to the drawings.

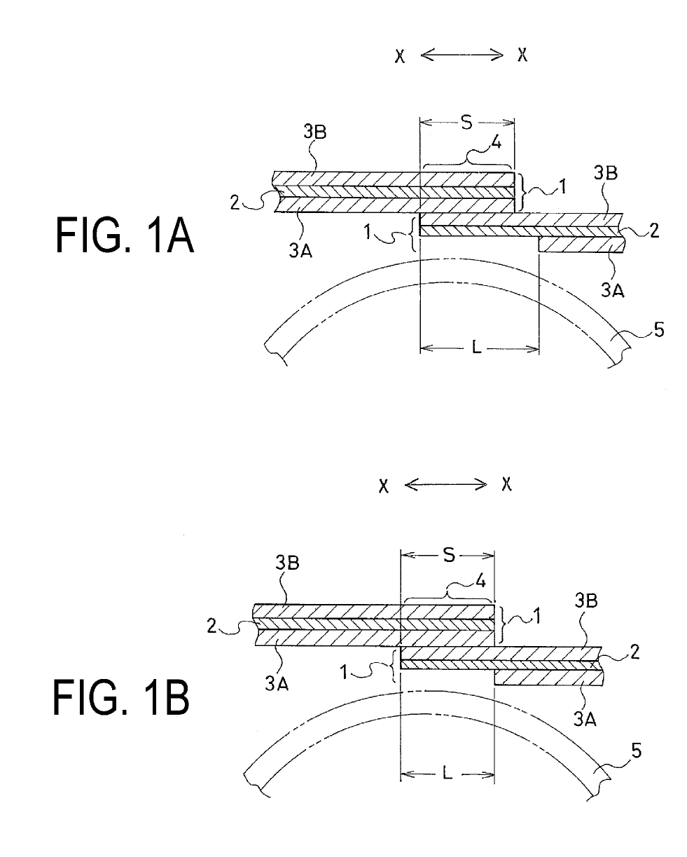

As illustrated in FIGS. 1A and 1B, the pneumatic tire of the present technology is a pneumatic tire having an innerliner member 1 attached to a tire inner circumferential surface, the innerliner member 1 constituted from at least three layers including a film 2 having, as a main component, a thermoplastic resin or a thermoplastic elastomer composition containing a blend of a thermoplastic resin and an elastomer, and rubber sheets 3A, 3B layered on both sides of the film 2, the tire including a lap splice structure in which tire circumferential direction end portions of the film 2 are overlapped with the rubber sheets 3A, 3B interposed therebetween, wherein the rubber sheet 3A on a tire cavity side of the innerliner member 1 disposed on the tire cavity side in the lap splice portion 4 is formed shorter along the tire circumferential length than an adjacent film 2.

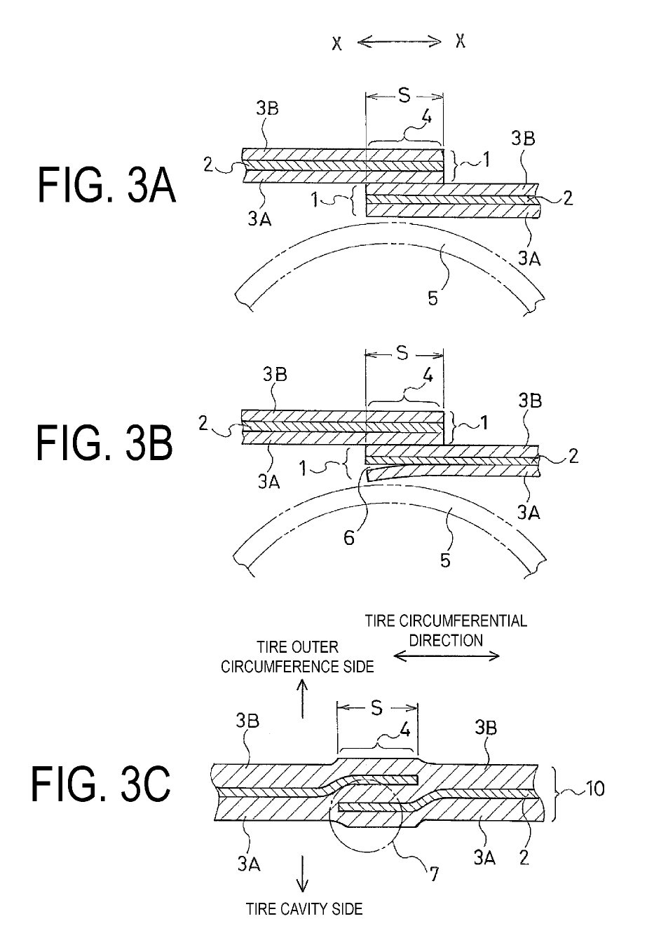

In FIGS. 1A and 1B, reference sign L denotes the length for which the rubber sheet 3A on the tire cavity side of the innerliner member 1 disposed on the tire cavity side in the lap splice portion 4 is formed shorter along the tire circumferential length than the adjacent film 2 (the difference in their circumferential lengths). According to the present technology, the rubber sheet 3A on the tire cavity side of the innerliner member 1 disposed on the tire cavity side in the lap splice portion 4 is formed shorter along the tire circumferential length than the adjacent film 2. This prevents adhesion bonding between the rubber sheet 3A on the tire cavity side and the forming drum due to compression bonding during lap splicing. As a result, the separation phenomenon (reference sign 6 of FIG. 3B) between the film 2 and the rubber sheet 3A can be suppressed.

On the other hand, due to the innerliner member 1 (film 2) having a lap splice structure in which the two ends are overlapped with the rubber sheets 3A and 3B interposed therebetween, splicing is achieved by bonding of rubber to rubber, and a good splice can be realized.

It is preferred that the difference (L) in circumferential length between the rubber sheet 3A on the tire cavity side and the film 2 having a thermoplastic elastomer composition as a main component in the innerliner member 1 disposed on the tire cavity side in the lap splice portion 4, and the lap splice length (S) of the film 2 having a thermoplastic elastomer composition as a main component hold the relationship L≧S. An aspect in which this relationship is satisfied is illustrated in FIG. 1A. When configured so as to satisfy this relationship, the total thickness of the lap splice portion 4 is thin and more uniform, resulting in little impairment to homogeneity (uniformity) of the tire, which is desirable. The aspect illustrated in FIG. 1B is an aspect in which L=S. In contrast to the aspects illustrated in these drawings, in an aspect in which the relationship is L<S, homogeneity (uniformity) of the tire is adversely affected because there is a portion where the total thickness of the lap splice portion 4 is fairly thick, which is undesirable compared to the aspects illustrated in FIGS. 1A and 1B.

According to findings by the present inventors, the difference (L) in circumferential length between the rubber sheet 3A on the tire cavity side and the film 2 having a thermoplastic elastomer composition as a main component in the innerliner member 1 disposed on the tire cavity side in the lap splice portion 4 is preferably not less than 5 mm and not greater than 50 mm. When the difference in circumferential length (L) is less than 5 mm, the adhesion force between the green tire and the forming drum during formation is greater, the advantageous effect of the present technology is smaller, and the separation phenomenon occurs more readily, which are undesirable. When the difference is longer than 50 mm, the weight balance on the circumference of the tire is adversely affected and uniformity may be adversely affected, which are undesirable.

Furthermore, the lap splice length (S) of the film 2 having a thermoplastic elastomer composition as a main component is in a range of from 3 to 30 mm. When the lap splice length (S) is less than 3 mm, opening of the lap splice portion 4 tends to occur. If the length is greater than 30 mm, the rigidity of the lap splice portion 4 is too high compared to the peripheral portion thereof. As a result, homogeneity (uniformity) of the tire is adversely affected, which is undesirable.

In the present technology, the film 2 is a film having a thermoplastic resin as a main component, or a film having, as a main component, a thermoplastic elastomer composition containing a blend of a thermoplastic resin and an elastomer.

As the resin that can be employed in the film 2, thermoplastic resin or thermosetting resin may be used, but thermoplastic resin is preferred due to its good ease of handling. The thermoplastic resin will be described in detail below. Preferred examples of the thermosetting resin include an epoxy resin, a phenolic resin, a urea resin, a melamine resin, an unsaturated polyester, a silicone resin, and a polyurethane resin.

Examples of the thermoplastic resin that can be used in the film 2 include a polyamide resin (e.g., nylon 6 (N6), nylon 66 (N66), nylon 46 (N46), nylon 11 (N11), nylon 12 (N12), nylon 610 (N610), nylon 612 (N612), a nylon 6/66 copolymer (N6/66), a nylon 6/66/610 copolymer (N6/66/610), nylon MXD6 (MXD6), nylon 6T, nylon 9T, a nylon 6/6T copolymer, a nylon 66/PP copolymer, a nylon 66/PPS copolymer) and an N-alkoxyalkyl compound thereof, e.g., a methoxymethyl compound of nylon 6, a methoxymethyl compound of a nylon 6/610 copolymer, or a methoxymethyl compound of nylon 612; a polyester resin (e.g., an aromatic polyester such as polybutylene terephthalate (PBT), polyethylene terephthalate (PET), polyethylene isophthalate (PEI), a PET/PEI copolymer, polyarylate (PAR), polybutylene naphthalate (PBN), a liquid crystal polyester, a polyoxyalkylene diimide acid/polybutylene terephthalate copolymer); a polynitrile resin (e.g., polyacrylonitrile (PAN), polymethacrylonitrile, an acrylonitrile/styrene copolymer (AS), a (meta)acrylonitrile/styrene copolymer, a (meta)acrylonitrile/styrene/butadiene copolymer), a polymethacrylate resin (e.g., polymethyl-methacrylate (PMMA), polyethyl-methacrylic acid), a polyvinyl resin (e.g., polyvinyl acetate, a polyvinyl alcohol (PVA), a vinyl alcohol/ethylene copolymer (EVOH), polyvinylidene chloride (PVDC), polyvinylchloride (PVC), a vinyl chloride/vinylidene chloride copolymer, a vinylidene chloride/methyl acrylate copolymer, a vinylidene chloride/acrylonitrile copolymer (ETFE)), a cellulose resin (e.g., cellulose acetate, cellulose acetate butyrate), a fluoride resin (e.g., polyvinylidene difluoride (PVDF), polyvinyl fluoride (PVF), polychlorofluoroethylene (PCTFE), a tetrafluoroethylene/ethylene copolymer), and an imide resin (e.g., an aromatic polyimide (PI)).

Among these, a polyester resin and a polyamide resin are preferred due to their physical properties, processability, and ease of handling.

Furthermore, for the resin and elastomer that constitute the blend (resin composition) that can be used to constitute the film 2, the above may be used as the resin (thermoplastic resin). Preferable examples of the elastomer constituting the blend (resin composition) include a diene rubber or a hydrogenate thereof (e.g., a natural rubber (NR), an isoprene rubber (IR), an epoxidized natural rubber, a styrene butadiene rubber (SBR), a butadiene rubber (BR, high cis-BR, and low cis-BR), a nitrile rubber (NBR), hydrogenated NBR, hydrogenated SBR), an olefin rubber (e.g., an ethylene propylene rubber (EPDM, EPM), a maleic acid modified ethylene propylene rubber (M-EPM), a butyl rubber (IIR), an isobutylene and aromatic vinyl or diene-based monomer copolymer, an acrylic rubber (ACM), an ionomer), a halogen-containing rubber (e.g., Br-IIR, CI-IIR, a brominated isobutylene-p-methylstyrene copolymer (BIMS), a chloroprene rubber (CR), a hydrin rubber (CHR), a chlorosulfonated polyethylene rubber (CSM), a chlorinated polyethylene rubber (CM), a chlorinated polyethylene rubber modified with maleic acid (M-CM)), a silicone rubber (e.g., a methyl vinyl silicone rubber, a dimethyl silicone rubber, a methylphenyl vinyl silicone rubber), a sulfur-containing rubber (e.g., a polysulfide rubber), a fluororubber (e.g., a vinylidene fluoride rubber, a vinyl ether rubber containing fluoride, a tetrafluoroethylene-propylene rubber, a silicon-based rubber containing fluoride, a phosphazene rubber containing fluoride), and a thermoplastic elastomer (e.g., a styrene elastomer, an olefin elastomer, an ester elastomer, a urethane elastomer, a polyamide elastomer).

In particular, it is preferable for not less than 50 wt. % of the elastomer to be a halogenated butyl rubber, a brominated isobutylene-paramethyl-styrene copolymer rubber, or a maleic anhydride-modified ethylene a olefin copolymer rubber from the perspective of being capable of increasing the rubber volume ratio so as to soften and enhance the durability of the elastomer at both low and high temperatures.

In addition, it is preferable for at least 50 wt. % of the thermoplastic resin in the blend to be any one of nylon 11, nylon 12, nylon 6, nylon 6, nylon 66, a nylon 6/66 copolymer, a nylon 6/12 copolymer, a nylon 6/10 copolymer, a nylon 4/6 copolymer, a nylon 6/66/12 copolymer, aromatic nylon, or an ethylene/vinyl alcohol copolymer from the perspective of excellent durability.

Moreover, when the compatibility is different upon obtaining a blend by blending a combination of the previously specified thermoplastic resin and the previously specified elastomer, a suitable compatibility agent may be used as a third component to enable compatibilization of both the resin and the elastomer. Mixing of the compatibility agent in the blend reduces interfacial tension between the thermoplastic resin and the elastomer. As a result, the particle size of the elastomer that forms a dispersion phase becomes very small and thus the characteristics of both components may be exhibited effectively. In general, such a compatibility agent has a copolymer having the structure of both or either the thermoplastic resin and the elastomer, or a copolymer structure having an epoxy group, a carbonyl group, a halogen group, an amino group, an oxazoline group, or a hydroxyl group, which is capable of reacting with the thermoplastic resin or the elastomer. While the type of compatibility agent may be selected according to the type of thermoplastic resin and elastomer to be blended, such a compatibility agent generally includes a styrene/ethylene butylene block copolymer (SEBS) or a maleic acid modified compound thereof; an EPDM, EPM, EPDM/styrene or EPDM/acrylonitrile graft copolymer or a maleic acid modified compound thereof; a styrene/maleic acid copolymer, and a reactive phenoxy. The blending amount of such a compatibility agent is not particularly limited, but may preferably be from 0.5 to 10 parts by weight relative to 100 parts by weight of the polymer components (the total amount of the thermoplastic resin and the elastomer).

A composition ratio of the specified thermoplastic resin to the elastomer in the blend obtained by blending a thermoplastic resin with an elastomer is not particularly limited. The composition ratio may be determined as appropriate to establish a dispersed structure as a discontinuous phase of the elastomer in the matrix of the thermoplastic resin, and is preferably within a weight ratio range of from 90/10 to 30/70.

In the present technology, a compatibility agent or other polymers may be blended with the thermoplastic resin or the blend of a thermoplastic resin blended with an elastomer, within a range that does not harm the characteristics required for constituting the film 2, for example. The purposes of mixing such a polymer are to improve the compatibility between the thermoplastic resin and the elastomer, to improve the forming processability of the material, to improve the heat resistance, to reduce cost, and the like. Examples of the material used for the polymer include polyethylene (PE), polypropylene (PP), polystyrene (PS), acrylonitrile butadiene styrene (ABS), polystyrene-butadiene-styrene (SBS), and polycarbonate (PC).

Furthermore, a reinforcing agent such as a filler (calcium carbonate, titanium oxide, alumina, and the like), carbon black, or white carbon, a softening agent, a plasticizer, a processing aid, a pigment, a dye, or an anti-aging agent that are generally compounded with polymer compounds may be optionally compounded so long as the required characteristics as the film 2 are not hindered. The blend of a thermoplastic resin and an elastomer has a structure in which the elastomer is dispersed as a discontinuous phase in the matrix of the thermoplastic resin. Due to such a structure, forming processability equal to that of a thermoplastic resin can be obtained.

Furthermore, the elastomer blended with the thermoplastic resin can be dynamically vulcanized when being mixed with the thermoplastic resin. A vulcanization agent, a vulcanization aid, vulcanization conditions (temperature, time), and the like, in the dynamic vulcanization can be determined as appropriate in accordance with the composition of the elastomer to be added, and are not particularly limited.

When the elastomer in the thermoplastic resin composition is dynamically vulcanized in this manner, the obtained film contains a vulcanized elastomer. Therefore, the film has resistance (elasticity) against deformation from the outside, which is preferable in that the effect of the present technology can be enhanced.

Generally available rubber vulcanization agent (crosslinking agents) can be used as the vulcanization agent. Specifically, as a sulfur-based vulcanization agent, powdered sulfur, precipitated sulfur, highly dispersible sulfur, surface treated sulfur, insoluble sulfur, dimorpholine disulfide, alkylphenol disulfide, and the like can be exemplified. For example, from approximately 0.5 to 4 phr (in the present specification, “phr” refers to parts by weight per 100 parts by weight of an elastomer component; similarly hereinafter) can be used.

Additionally, examples of organic peroxide-based vulcanization agents include benzoyl peroxide, t-butyl hydroperoxide, 2,4-dichlorobenzoyl peroxide, 2,5-dimethyl-2,5-di(t-butylperoxy)hexane, and 2,5-dimethylhexane-2,5-di(peroxyl benzoate). Vulcanization agents can be used in an amount, for example, from approximately 1 to 20 phr.

Furthermore, examples of the phenol resin-based vulcanization agents include brominated alkylphenol resins and mixed crosslinked systems containing an alkyl phenol resin and a halogen donor such as tin chloride or, chloroprene,. Vulcanization agents can be used in an amount, for example, from approximately 1 to 20 phr.

Examples of other vulcanization agents include zinc oxide (approximately 5 phr), magnesium oxide (approximately 4 phr), litharge (from approximately 10 to 20 phr), p-quinone dioxime, p-dibenzoylquinone dioxime, tetrachloro-p-benzoquinone, poly-p-dinitrosobenzene (from approximately 2 to 10 phr), and methylenedianiline (from approximately 0.2 to 10 phr).

As necessary, a vulcanization accelerator may be added. For the vulcanization accelerator, generally available vulcanization accelerators such as aldehyde-ammonia-based, guanidine-based, thiazole-based, sulfenamide-based, thiuram-based, dithioic acid salt-based, and thiourea-based vulcanization accelerators can be used in an amount of, for example, from approximately 0.5 to 2 phr.

Here, the weight ratio of thermoplastic resin to elastomer in the blend is not particularly limited but is preferably set to from 10/90 to 80/20, and more preferably from 20/80 to 70/30. The weight ratio should be adjusted so that the elastomer component in the thermoplastic resin matrix is dispersed homogeneously as a discontinuous phase.

Furthermore, as the rubber material that constitutes the rubber sheets, diene rubbers such as natural rubber, isoprene rubber, epoxidized natural rubber, styrene-butadiene rubber, and hydrogenated styrene-butadiene rubber, or olefin-based rubbers such as ethylene-propylene rubber and maleic acid modified ethylene-propylene rubber may be advantageously used.

Furthermore, to increase adhesion between the film 2 and the adjacent rubber sheets, they may be layered with an adhesive layer interposed therebetween. As the polymer that constitutes the adhesive layer, an ultra high molecular weight polyethylene having a molecular weight of not less than 1000000 and preferably not less than 3000000; acrylate copolymers such as ethylene-ethylacrylate copolymers, ethylene-methylacrylate resins, and ethylene-acrylic acid copolymers, and maleic anhydrate adducts thereof; polypropylene and maleic acid-modified products thereof; ethylene-propylene copolymers and maleic acid-modified products thereof; polybutadiene resins and maleic anhydrate-modified products thereof, styrene-butadiene-styrene copolymers; styrene-ethylene-butadiene-styrene copolymers; thermoplastic fluororesins; thermoplastic polyester resins; and the like are used.

In the present technology, the thickness of the film 2 is not particularly limited, but typically, from approximately 0.002 to 0.3 mm is preferred. Furthermore, the thickness of each of the rubber sheets 3A, 3B is not particularly limited, but a thickness from 0.1 to 1.8 mm and preferably from 0.2 to 1.0 mm is practical. When the rubber sheet thickness is less than 0.1 mm, the operation of layering on the film 2 is more difficult. A thickness of greater than 1.8 mm results in an increase in tire weight, which is undesirable.

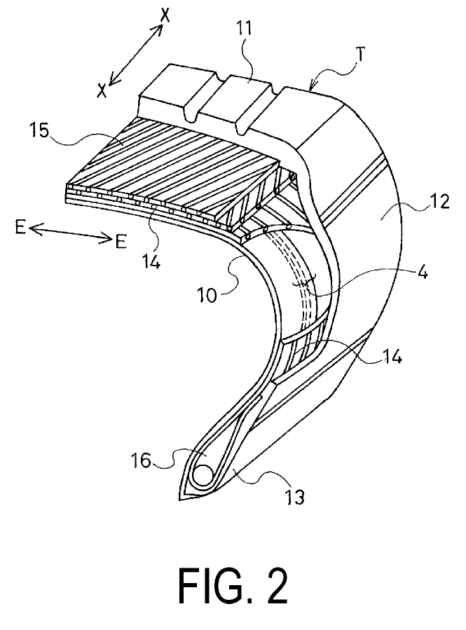

FIG. 2 is a partially fragmented perspective view illustrating an example of an embodiment of the pneumatic tire according to the present technology.

A pneumatic tire T is provided with a tread portion 11, sidewall portions 12, and bead portions 13. The sidewall portions 12 and the bead portions 13 are connected on the left and right of the tread portion 11. On the tire inner side of the pneumatic tire T, a carcass layer 14 that acts as a framework of the tire is provided so as to extend between the left and right bead portions 13, 13 in the tire width direction. Two belt layers 15 composed of steel cords are provided on the outer circumferential side of the carcass layer 4 corresponding to the tread portion 11. The arrow E indicates the tire width direction, and the arrow X indicates the tire circumferential direction. An innerliner layer 10 is disposed on an inner side of the carcass layer 14, and a lap splice portion 4 thereof is present extending in the tire width direction.

In the pneumatic tire according to the present technology, the generation of cracks, the occurrence of separation, and the occurrence of opening of the bond portion that conventionally tend to occur in the vicinity of the lap splice portion 4 on the tire inner circumferential surface during tire vulcanization molding and after the start of travel are suppressed, and productivity and durability are noticeably improved.

### Examples

The pneumatic tire of the present technology will be specifically described below by examples and the like.

The pneumatic tire is evaluated by the methods described below in regard to delamination resistance (separation resistance) in the green tire, delamination resistance (separation resistance) in the product tire, and tire uniformity.

As test tires, 20 tires were produced for each of the examples (Examples 1 to 5) and the comparative example using 195/65R15 91H. They were mounted on a JATMA (Japan Automobile Tyre Manufacturers Association, Inc.) standard rim 15×6J, and submitted to testing.

Comparative Example 1 had the conventional splice structure illustrated in FIG. 3A, and the tires of the examples of the present technology had the structures illustrated in FIGS. 1A and 1B. The values of (S) and (L) of each of the examples are shown in Table 1. The film was 0.1 mm thick, and the rubber sheets were 0.5 mm thick.
(a) Delamination resistance (separation resistance) in green tire:

In the completed green state, the tire inner surface of the splice portion of the innerliner was checked to ascertain the presence/absence of delamination. It was ascertained by visual observation.
(b) Delamination resistance (separation resistance) in product tire: Using a drum testing machine, the tire was made to travel for 80 hours at an internal tire pressure of 120 kPa, load of 7.24 kN, and speed of 81 km/h, and the tire inner surface of the splice portion of the innerliner was checked to ascertain the presence/absence of delamination. It was ascertained by visual observation.
(c) Tire uniformity test: RFV (maximum radial force deformation) was measured according to JASO C-607-87. It was evaluated by determining the average value with n=10. The results were expressed as an index, taking the conventional splice structure tire (Comparative Example 1) as 100. A higher numeric value indicates a superior tire, and 5% was judged to be a significant difference.

The specifications of each of the above test tires are shown together with the evaluation results in Table 1.

As shown in Table 1, in the pneumatic tire according to the present technology, there is no occurrence of failures such as delamination or cracking in the vicinity of the lap splice portion, either during green tire forming, after vulcanization molding of the tire, or after the pneumatic tire starts to travel.

TABLE 1

| | Com- | Ex- | Ex- | Ex- | Ex- | Ex- |
|---|---|---|---|---|---|---|
| | parative | ample | ample | ample | ample | ample |
| | Example 1 | 1 | 2 | 3 | 4 | 5 |
| Length | Absent | Present | Present | Present | Present | Present |
| difference | | (5 mm) | (5 mm) | (30 mm) | (30 mm) | (20 mm) |
| between | | | | | | |
| film and | | | | | | |
| rubber sheet | | | | | | |
| (L) (mm) | | | | | | |
| Lap splice | 10 mm | 5 mm | 30 mm | 20 mm | 30 mm | 30 mm |
| length | | | | | | |
| of film | | | | | | |
| (S) (mm) | | | | | | |
| Presence/ | Present | Absent | Absent | Absent | Absent | Absent |
| absence of | | | | | | |
| delamination | | | | | | |
| (green tire) | | | | | | |
| Presence of | Present | Absent | Absent | Absent | Absent | Absent |
| delamination | | | | | | |
| (after tire | | | | | | |
| travels) | | | | | | |
| Uniformity | 100 | 101 | 99 | 105 | 101 | 99 |

1. A pneumatic tire comprising an innerliner member attached to a tire inner circumferential surface, the innerliner member constituted from at least three layers including a film having, as a main component, a thermoplastic resin or a thermoplastic elastomer composition containing a blend of a thermoplastic resin and an elastomer, and rubber sheets layered on both sides of the film, the tire including a lap splice portion in which tire circumferential direction end portions of the film are overlapped with the rubber sheets interposed therebetween; wherein the rubber sheet on a tire cavity side of the innerliner member disposed on the tire cavity side in the lap splice portion is formed shorter along the tire circumferential length than the adjacent film.

2. The pneumatic tire according to claim 1, wherein a relationship between a difference (L) in circumferential length between the rubber sheet on the tire cavity side and the film having a thermoplastic elastomer composition as a main component in the innerliner member disposed on the tire cavity side in the lap splice portion, and a lap splice length (S) of the film having a main component of a thermoplastic elastomer composition, is L≧S.

3. The pneumatic tire according to claim 1, wherein the difference (L) in circumferential length between the rubber sheet on the tire cavity side and the film having a thermoplastic elastomer composition as a main component in the innerliner member disposed on the tire cavity side in the lap splice portion is not less than 5 mm and not greater than 50 mm.

4. The pneumatic tire according to claim 1, wherein the lap splice length (S) of the film having a thermoplastic elastomer composition as a main component is in a range of from 3 to 30 mm.

5. The pneumatic tire according to claim 2, wherein the difference (L) in circumferential length between the rubber sheet on the tire cavity side and the film having a thermoplastic elastomer composition as a main component in the innerliner member disposed on the tire cavity side in the lap splice portion is not less than 5 mm and not greater than 50 mm.

6. The pneumatic tire according to claim 5, wherein the lap splice length (S) of the film having a thermoplastic elastomer composition as a main component is in a range of from 3 to 30 mm.

7. The pneumatic tire according to claim 2, wherein the lap splice length (S) of the film having a thermoplastic elastomer composition as a main component is in a range of from 3 to 30 mm.

8. The pneumatic tire according to claim 3, wherein the lap splice length (S) of the film having a thermoplastic elastomer composition as a main component is in a range of from 3 to 30 mm.
